(19) United States
(12) Patent Application Publication
(10) Pub. No.: US 2024/0309487 A1
(43) Pub. Date: Sep. 19, 2024

(54) Systems and Methods for Modifying Metal Feedstock Material

(71) Applicant: California Institute of Technology, Pasadena, CA (US)

(72) Inventors: Douglas C. Hofmann, Altadena, CA (US); Punnathat Bordeenithikasem, Pasadena, CA (US)

(73) Assignee: California Institute of Technology, Pasadena, CA (US)

(21) Appl. No.: 18/604,340

(22) Filed: Mar. 13, 2024

Related U.S. Application Data
(60) Provisional application No. 63/451,676, filed on Mar. 13, 2023.

(51) Int. Cl. C22B 7/00; C22C 1/11; C22C 45/00; C22C 45/06

(52) U.S. Cl. CPC C22B 7/003; C22C 1/11; C22C 45/001; C22C 45/06

(57) ABSTRACT

Systems and alloying methods for forming metals are described. Waste materials from various industrial processes and botched master alloy production heats result in numerous byproducts that can form constituent components for the formation of bulk alloys with higher value and more diverse applications. Reusing and upcycling industrial byproducts into material with specific structure and properties result in additional commercial and industrial applications and value.

### CROSS REFERENCE TO RELATED APPLICATIONS

This application claims priority to U.S. Provisional Application No. 63/451,676, entitled “Systems and Methods for Modifying Titanium and Zirconium Metal Feedstock Material Using the Addition of Correction Metal” to Hofmann et al., filed Mar. 13, 2023, the disclosure of which is incorporated by reference herein in its entirety.

### STATEMENT OF FEDERAL FUNDING

This invention was made with government support under Grant No. 80NMO0018D0004 awarded by NASA (JPL). The government has certain rights in the invention.

### FIELD OF THE INVENTION

This application generally relates to group four alloys and amorphous metals. More specifically, it relates to systems, methods, and processes for alloying waste material and manufacturing byproducts to form bulk alloys.

### BACKGROUND

Metals are widely used in manufacturing, and metal feedstock materials are essential components of many manufacturing processes. Feedstock materials are often produced on a large scale and divided into smaller portions to be sold to manufacturers for fabrication. In many cases, the feedstock materials are designed for particular manufacturing processes with specific requirements, such as injection molding, casting, machining, 3D printing, welding, forging, and rolling.

To ensure that the final product meets the customer's requirements, the feedstock materials often need to meet strict material certifications and/or specifications that describe the overall composition, purity, and the amount and type of impurities that are required or allowed.

Producing metal feedstock materials that meet customer specifications is not always straightforward. Some metal alloys, such as those with elements that readily react with oxygen or with crucible materials, are particularly susceptible to contamination, more difficult to manufacture in large batches or without highly specialized equipment, and more likely to result in feedstock that does not satisfy specifications. Similarly, alloys with large differences between their constituent elements melting temperatures are difficult to manufacture at scale and are also particularly prone to complications. Feedstock material that does not meet specifications will often be rejected by customers and can result in significant losses for the producer. As a result, there is a need for processes that make use of scrap and waste materials.

### SUMMARY OF THE INVENTION

Devices and methods in accordance with some embodiments of the invention are directed recycling, processing, and reprocessing of alloys and alloy feedstock, advanced alloy combinations, the formation of bulk amorphous metals, and methods for their manufacture and use.

Many embodiments of the disclosure are directed to processes for recycling metal waste material into an alloy comprising, providing a mongrel alloy that contains at least one contaminant wherein the at least one contaminant inhibits the formation of a selected structure with at least one selected property such that the addition of a percentage of uncontaminated mongrel alloy is insufficient for the formation of the selected structure, combining an optimized ratio of the mongrel alloy and a correction alloy in a melting process configured to form a target alloy, heating the mongrel alloy and the correction alloy until molten, combining the molten mongrel and correction alloys into a homogenous combination, solidifying the homogenous combination, wherein the solidified homogenous combination is of the selected structure and the at least one selected property.

In many embodiments, the mongrel alloy is predominately crystalline.

In some embodiments, the mongrel alloy is at least 50% by mass group IV elements from the periodic table.

In several embodiments, the at least one contaminant is selected from the group consisting of O, C, other metal, ceramic, and inclusions.

In numerous embodiments, the selected structure is a predominantly amorphous or glassy structure.

In various embodiments, the percentage is 50% or less.

In some embodiments, the mongrel alloy equals or exceeds the mass of the correction alloy.

In many embodiments, the optimized ratio between the mongrel alloy and the correction alloy is selected from the group consisting of, 50:50, 55:45, 60:40, 65:35, 70:30, 75:25, 80:20, 85:15, 90:10, and 95:5.

In several embodiments the process further comprises performing a manufacturing operation on the homogenous combination selected from the group consisting of casting, forging, extruding, atomizing, drawing, rolling, or melt spinning.

The process of claim 1 wherein the mongrel alloy is Ti40Zr20Cu5Al5Be30 in atomic % plus the at least one contaminant.

In some embodiments, the mongrel alloy is Ti90Al6V4 in weight % plus the at least one contaminant.

In numerous embodiments, the correction alloy predominantly comprises at least one element or combination selected from the group consisting of Zr, Ti, Cu, Ni, Fe, Nb, Ta, V, Al, and Be.

In several embodiments, the correction alloy is selected from the group consisting of Zr46Cu54, Zr69Cu31, Zr75Cu25, Zr79Cu20Al1, Zr100, and Zr67Ni26Cu7.

In many embodiments, the target alloy comprises the constituent elements of the mongrel alloy.

In various embodiments, the at least one selected property of the target alloy exceeds the at least one selected property of the mongrel alloy.

In many embodiments, the property is selected from the group consisting of strength, hardness, ductility, modulus, fatigue limit, wear resistance, abrasive resistance, density, thermal conductivity, solidus temperature, melting point, viscosity, color or appearance, elastic strain limit, biocompatibility, operating temperature, reactivity, castability, fracture toughness, and impact toughness.

In many embodiments, the target alloy has a yield strength of at least 1.0 GPa, a Young's modulus less than 150 GPa, a hardness greater than 400 Hv, and an elastic strain limit of greater than 1.4% before yielding.

In some embodiments, the target alloy has a glass forming ability of 3 mm amorphous and 2 GPa strength.

In various embodiments, correction alloy is optimized for the least additions.

In several embodiments, the target alloy is optimized for the least additions.

Many embodiments of the disclosure are directed to a process for recycling waste material into bulk metallic glass alloy comprising, providing a predominantly crystalline mongrel alloy that is at least 50% by mass group four elements and contains O or C, inhibiting the formation of a predominantly amorphous structure, combining an optimized ratio of the mongrel alloy and a correction alloy in a furnace configured to form a target alloy, wherein the mongrel alloy equals or exceeds the mass of the correction alloy, heating the mongrel alloy and the correction alloy until molten, combining the molten mongrel and correction alloys into a homogenous combination, quenching the homogenous combination, wherein the quenched homogenous combination is predominantly amorphous.

In various embodiments, the mongrel alloy is Ti40Zr20Cu5Al5Be30 in weight %.

In some embodiments, the mongrel alloy is Ti90Al6V4 in weight %.

In numerous embodiments, the mongrel alloy is titanium, zirconium, or hafnium.

In various embodiments, the correction alloy is selected from the group consisting of Zr, Cu, or a combination of Zr and Cu.

In several embodiments, the optimized ratio is 75:25 mongrel alloy to correction alloy.

Numerous embodiments of the disclosure are directed to a process for recycling waste material into bulk metallic glass alloy comprising, providing a predominantly crystalline alloy that is at least 50% by mass group four elements and contains a contaminant, inhibiting the formation of a predominantly amorphous structure, combining an optimized ratio of the predominantly crystalline alloy and a correction alloy in a furnace configured to form a target alloy, wherein the predominantly crystalline alloy equals or exceeds the mass of the correction alloy, heating the mongrel alloy and the correction alloy until molten, combining the molten predominantly crystalline alloy and correction alloys into a homogenous combination, quenching the homogenous combination, wherein the quenched homogenous combination is predominantly amorphous.

In some embodiments, the predominantly crystalline alloy is Ti90Al6V4 in weight %.

In various embodiments, the correction alloy consists of Zr, CU, and Be.

In some embodiments, the optimized ratio is 50:50 predominantly crystalline alloy to correction alloy.

Additional embodiments and features are set forth in part in the description that follows, and in part will become apparent to those skilled in the art upon examination of the specification or may be learned by the practice of the disclosure. A further understanding of the nature and advantages of the present disclosure may be realized by reference to the remaining portions of the specification and the drawings, which forms a part of this disclosure.

### BRIEF DESCRIPTION OF THE DRAWINGS

The description will be more fully understood with reference to the following figures, which are presented as embodiments of the invention and should not be construed as a complete recitation of the scope of the invention, wherein:

FIG. 1 illustrates the properties of various alloys that can be processed in accordance with various embodiments.

FIG. 2 illustrates an exemplary alloy combination in accordance with some embodiments.

FIG. 3 depicts a flow chart for a method of processing materials in accordance with various embodiments.

FIG. 4 illustrates a composition map of possible material combinations that can be combined in accordance with some embodiments.

FIGS. 5A through 5D provide exemplary data showing XRD, DSC, and four-point bending test results for samples prepared in accordance with some embodiments.

FIG. 6 shows the composition of the correction alloys and target alloys in accordance with exemplary embodiments.

FIG. 7 illustrates exemplary XRD data characterizing samples processed in accordance with various embodiments.

FIG. 8 illustrates exemplary DSC data characterizing samples processed in accordance with various embodiments.

FIG. 9 illustrates exemplary four-point bending data characterizing samples processed in accordance with various embodiments.

FIG. 10 shows the composition and properties of exemplary alloys processed in accordance with various embodiments.

### DETAILED DESCRIPTION OF THE INVENTION

Amorphous metals, also known as metallic glasses, are metal alloys with an amorphous atomic structure. This atomic arrangement results from rapid solidification of the metal alloys without allowing sufficient time for crystallization. The rapid cooling leads to a random yet highly homogenous arrangement of atoms. These alloys exhibit exceptional properties, including high stability, corrosion and wear resistance, and high elasticity, making them versatile and suited for numerous applications. Additionally, amorphous metals demonstrate high tensile strength and can be processed with techniques similar to plastic fabrication, allowing for greater flexibility in manufacturing. These unique properties make them an exciting and promising area of research in various industries, including aerospace, electronics, and healthcare.

Bulk metallic glasses (BMGs) are a type of amorphous metal alloy that is becoming more prevalent in manufacturing. Unlike crystalline metals, BMGs have an amorphous microstructure, which gives them unique properties and opens up alternative processing methods. BMGs are currently being used in a variety of industries, such as space, aerospace, medicine, sports, jewelry, and consumer electronics.

As the use of BMGs increases, so does the demand pressure on their supply chains. Therefore, it is important to identify and implement new and alternative sources for the constituent components of BMGs to prevent bottlenecks and constraints in the supply chain and enable the rapid growth and expansion of BMG adoption, production, and use.

### Group Four Alloys

Group four is the second group of transition metals in the periodic table. It contains four elements: titanium (Ti), zirconium (Zr), hafnium (Hf), and rutherfordium (Rf). The group is also called the titanium group or titanium family after its lightest member. Rutherfordium is strongly radioactive: it does not occur naturally and must be produced by artificial synthesis. All the group four elements are inherently reactive. However, their inherent reactivity is masked when solid due to the formation of a dense oxide layer that protects them from corrosion and attack by many acids and alkalis. Manufacturing group four alloys, such as titanium and zirconium alloys, can be difficult because they react with oxygen and crucible materials. Additionally, these alloys are challenging to fully homogenize during processing because they tend to form eutectic phases with alloying elements. As a result, group four alloy specifications are often very precise as their properties are highly sensitive to their phase.

The crystalline forms of group four alloys are usually beta phase (body centered cubic), the alpha phase (hexagonal closed packed) or a combination of both (alpha-beta) in terms of their atomic structure. The mechanical properties of these different crystalline structures are very different. For example, TiZrNb beta alloys are used in biomedical applications due to their soft and ductile nature, with a yield strength of less than 500 MPa and more than 15% ductility in tension tests. Meanwhile, alpha titanium alloys, such as Ti-5Al-1Sn and Ti-8Al-1Mo-1V, usually have a yield strength of greater than 500 MPa and less than 10% ductility in tension. Other alloys have both alpha and beta stabilizers to maximize properties. The widely used Grade 5 alloy of titanium, Ti-6Al-4V, is an alpha-beta alloy that has an ideal combination of strength and ductility. This alloy usually has a yield strength of greater than 800 MPa with greater than 10% ductility in tension.

Amorphous metal alloys and BMGs can also be achieved in group four alloys. This phase occurs when the group four elements are mixed with elements that lower the melting temperature enough that they can be quickly solidified without crystallizing, forming a glassy structure. By precisely controlling the composition, the alloys have a glass-forming ability (GFA), which is the thickest part that can be cast from the alloy in the amorphous state without being crystalline.

Regardless of their structural form, group four alloys need to be manufactured with precise tolerances on their composition and impurities. This is critical because even minor variations in composition can significantly alter the alloy's properties. For instance, beta-titanium alloys are known for being ductile and soft. However, even slight additions of alpha stabilizers, such as aluminum or oxygen, can rapidly increase the strength and reduce ductility. If the composition is not tightly controlled, the batches may need to be scrapped, which can be very costly.

To make the manufacturing of these alloys more sustainable, there is a need to develop methods to convert unusable, out-of-specification materials into usable alloys for manufacturing. However, in many cases, the mechanical properties of a feedstock alloy that is unsuitable for use in its intended application would (normally) have very little use in other applications. However, if out-of-specification alloys can be combined with another alloy (i.e., not simple dilution) to produce a new alloy that has useful properties, the “scrap” material could be saved and repurposed. Ideally, scrap alloy could be mixed with minimal new material to change its composition to a useful range.

In the case of amorphous metals, the material feedstock often needs to have a particular composition and purity level to form a glassy or amorphous structure. If the material is not pure enough, has the wrong composition, and cannot form an amorphous structure, it likely has very little value. However, if it can be modified to have the minimum glass-forming ability, and the final product has an amorphous structure, while it may not be able to be used for its original intended application, the composition will still likely be of greater value and able to be used in other applications relative to its previous crystalline counterpart.

### Bulk Metallic Glasses

Bulk metallic glasses (BMG) alloys often contain numerous elements and are challenging to refine due to their multi-component nature. Most engineering BMG alloys are based on group four elements, specifically zirconium (Zr), Titanium (Ti), or a combination of Zr and Ti. When BMG alloys are rapidly cooled during their manufacturing process, they form a glassy phase that makes up around 95% of their volume and exhibit mechanical properties that are similar to other amorphous BMGs of similar composition. For example, most Zr—Ti—Be-based BMGs have a yield strength of approximately 2 GPa, a 2% elastic strain limit to failure, and 0% tensile ductility. Depending on the composition, they typically have a hardness between 350-550 HV, and exhibit Young's moduli between 75-100 GPa.

Changes in composition can affect the BMGs' properties, such as plasticity in bending or compression, hardness, modulus, and corrosion or wear properties. However, these changes are subtle compared to the significant difference between an amorphous BMG and a fully crystalline alloy with the same composition. BMGs that are not sufficiently quenched form hard and brittle phases, which can reduce the yield strength and fracture toughness by an order of magnitude or more, and dramatically increase the hardness and modulus. Crystallized glass-forming alloys are known to be exceptionally brittle compared to amorphous BMGs and are generally unsuitable for many engineering applications requiring BMG properties. Consequently, material specifications for BMGs often have tight tolerances on composition and impurities as even small changes in composition, such as the inclusion of impurities such as oxygen and carbon, can negatively affect properties, (such as Glass-Forming Ability, wear resistance, strength, and plasticity).

Most BMG research has been conducted on laboratory-grade material, typically fabricated from high-purity constituent elements in small batches. These elements are most often weighed precisely and then alloyed using clean crucibles under inert atmospheres. However, scaling up BMG material for commercial production often requires industrial foundry capabilities, which can add impurities through both the feedstock material and the interactions between the alloys and the crucibles.

For group four BMGs, the feedstock material is highly susceptible to oxygen, is highly reactive, and exhibits “oxygen-getting behavior.” This behavior limits the number of cycles such alloys can go through before the increased oxygen content ultimately deteriorates the glass-forming ability. Oxygen from the raw materials and the environment and carbon from graphite crucibles can alter the composition of the BMG away from good glass-forming regions. The lot is often scrapped if BMG composition fails to meet the tight specifications required for high-performance applications.

Recycling and reusing commercially made BMG “scrap” feedstock material is challenging due to the multicomponent compositions of the BMG alloys. BMG alloys often contain numerous elements and impurities, such as Zr, Ti, Cu, Ni, Al, Be, O, and C. If impurity levels remain low, it is sometimes possible that the material can be reused or repurposed. If, however, the alloy batch strays too far away from useful compositions, it is often too costly or time-consuming to correct and is scrapped. However, in such cases, it may be possible to “upcycle” the BMG feedstock by mixing it with a designed alloy to create a new composition that has improved properties and can be formed into bulk glass.

### Embodiments

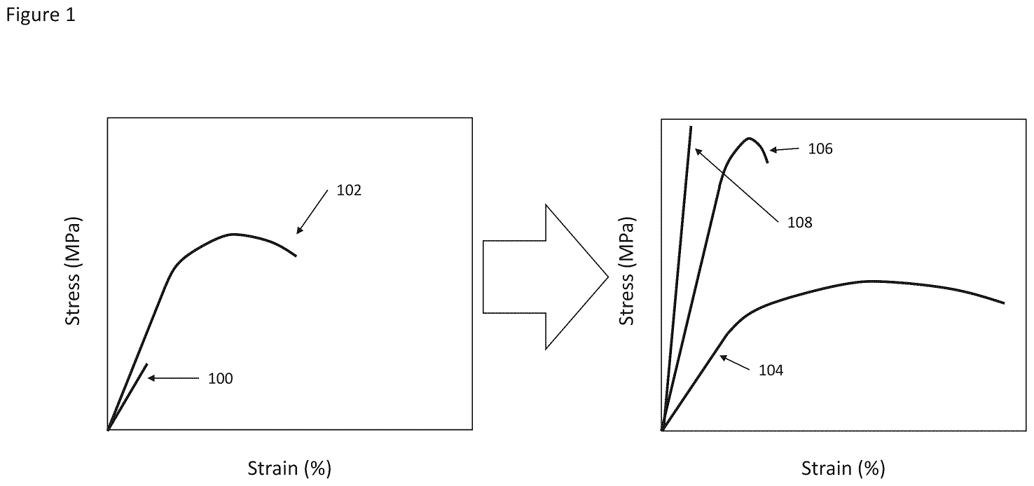

This disclosure includes several embodiments directed to methods of alloying and manufacturing group four alloys and BMGs. In accordance with numerous embodiments, these alloys and BMGs are manufactured from crystalline “scrap” materials with limited value or applications into new alloys with desirable properties that make them suitable for various applications. FIG. 1 illustrates the properties of various alloys that can be achieved by processing “scrap” in accordance with some embodiments. Waste stream (scrap) group four alloys can come in various forms: brittle alloys with low strength 100, ductile alloys with moderate strength 102, multi-phase alloys, etc. These scrap (mongrel) alloys can be reprocessed in accordance with many embodiments into alloys that have a wide variety of properties. In some embodiments, they can be made soft by adding beta stabilizers 104, be made amorphous 106, or can be made into high-strength wear resistance composites 108. As such and in accordance with numerous embodiments, the process of manufacturing group four alloys, such as titanium and zirconium alloys, can be made more sustainable by the conversion of unusable, waste stream material and out-of-specification feedstock materials into useable alloys for manufacturing.

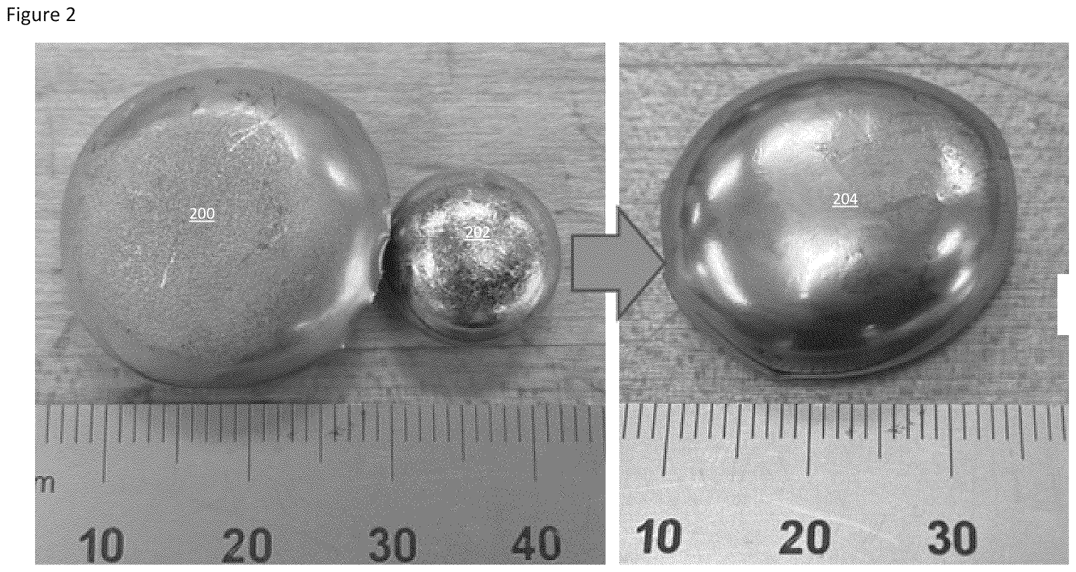

In many embodiments, the mongrel alloy's mechanical properties are unsuitable for use in its original application and may have very little use in any other application. In accordance with many such embodiments, and as illustrated in FIG. 2, an out-of-specification “mongrel” alloy 200 is mixed with another “correction” alloy 202 to produce a new “target” alloy 204 with useful properties, resulting in the scrap material being “saved,” i.e., not resulting in a complete loss to the producers. In some such embodiments, less than 50% additional material is needed, such as the 25% addition depicted in FIG. 2. In many embodiments, the scrap alloy is mixed with the minimum possible amount of “virgin material” to change its composition.

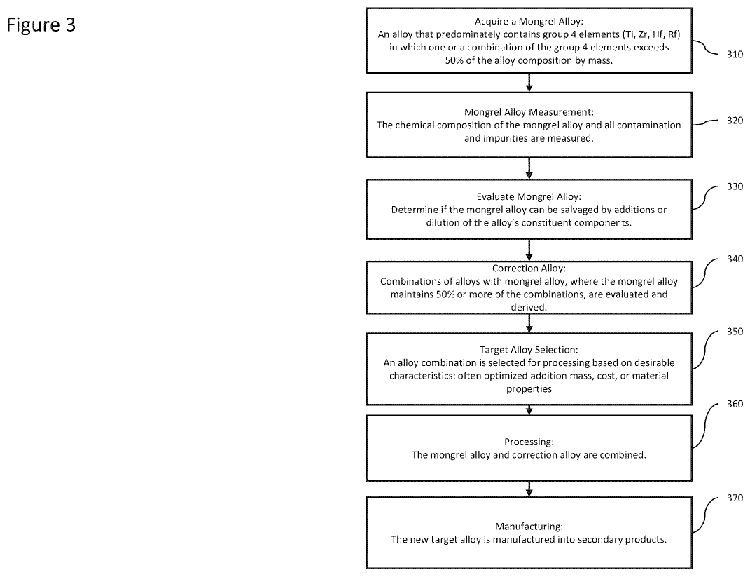

FIG. 3 depicts a flow chart for a method of processing waste materials into new bulk alloys in accordance with numerous embodiments. At step 310, waste stream material is acquired for processing. The waste stream material is a “mongrel” alloy that predominantly contains group four elements (Ti, Zr, Hf, Rf), and the concentration of the mongrel alloy's group four elements exceeds 50% of the alloy's mass. At step 320, the chemical composition of the mongrel alloy is measured to determine the main elements, and the contaminants and impurities present. The mongrel alloy will function as the main feedstock material, and as such, the composition of the alloy needs to be measured precisely. In many embodiments, the measurement is performed by mass spectrometry, Inductively Coupled Plasma Optical Emission Spectroscopy (ICP-OES), (Energy Dispersive X-ray Spectroscopy (EDS), or X-ray fluorescence (XRF). In other embodiments, the measurement is performed by other methods that would be known to one skilled in the art to determine precise compositions. At step 330, the mongrel alloy is evaluated to determine if the mongrel alloy can be salvaged for the intended application. In some scenarios, once the composition of the mongrel is determined, it will be able to be salvaged by additions or dilution of the alloy's constituent components to push the composition to the right balance. In many embodiments, the mongrel alloy composition is determined to be salvageable or unsuitable for manufacturing or applications by analyzing it through experiment and/or numerical methods. In many such embodiments, thermodynamic modeling, CALPHAD, phase diagram mapping, or other methods that would be known to one skilled in the art are utilized to predict the properties and phases of the alloy. Then, at step 340, if the mongrel alloy feedstock material is determined to be out of the specification for the intended application, potential correction alloys are devised that, when combined with the mongrel alloy, change the composition into target alloys with new or better properties. In many embodiments, the mongrel alloy forms the majority of the new target alloy mass, and the correction alloy is less than 50% of the mass of the combination. At step 350, once suitable alloy combinations are determined, a target alloy is selected for processing that possesses desirable characteristics, and a correction alloy ingot is prepared. In many embodiments, the correction and target alloys are selected and optimized for the mass of additions, cost of additions, and/or resulting target alloy properties. At step 360, the mongrel alloy and correction alloy are combined into the selected target alloy. In many embodiments, the alloys are melted and combined in a furnace, and the new target alloy is quenched. In some such embodiments, the alloys are combined with specialty equipment to limit the introduction of further contaminants and limit reactions such as vacuum induction melting furnaces, inert gas furnaces, cold crucible furnaces, or other equipment and methods to control reactions and alloy contamination that would be known to one skilled in the art. In many embodiments, the target alloy is cast, forged, rolled, drawn, extruded, or prepared for manufacturing by other methods that would be known to one skilled in the art. Then, at step 370, the new target alloy is manufactured into secondary products. In many embodiments, the target alloy is manufactured by casting, molding, stamping, machining, or other methods that would be known to one skilled in the art.

In many embodiments, the mongrel alloy is comprised of different elements and atomic compositions. In many such embodiments, the elements are predominately group four elements, such as titanium and zirconium and the sum of group four elements exceeds other elements. In numerous embodiments, the percentage of each element can increase or decrease after the addition of the correction alloy ingot. In other embodiments, some elements' percentages stay the same. In some embodiments, elements not contained in the mongrel alloy are added through the correction alloy ingot. In many embodiments, the amount of percentage increase or decrease of each element in the target alloy is constrained by the correction alloy ingot having a mass of less than 50% of the total mass of the target alloy ingot. In many such embodiments, combining the correction alloy with the mongrel alloy is optimized to minimize the required mass fraction of the correction alloy ingot. Similarly, in some embodiments, the correction alloy is optimized to maximize the desirable mechanical properties of the target alloy ingot. In some such embodiments, the amount of a correction alloy is optimized to form an amorphous metal target alloy with the minimum amount of correction alloy to form an amorphous structure. In other embodiments, the correction alloy is optimized for the best possible properties, such as the glass-forming ability, ductility, and/or strength. In some such embodiments, a higher mass fraction of additions is utilized to optimize material properties. In some embodiments, the correction alloy is optimized for the cost of its composition elements.

In many embodiments, to make the target alloy ingot, the mongrel alloy is combined with the correction alloy ingot as follows:

$${m}_{total}^{Target} = {m}_{total}^{Received} + {m}_{total}^{Correction}$$

In many embodiments, the correction alloy ingot is 50% or lower than the total mass of the target alloy ingot. Therefore:

mₜₒₜₐₗ^{Correction}<mₜₒₜₐₗ^{Received}

In many embodiments, the composition of the correction alloy ingot, based on the composition of the mongrel alloy ingot and the desired composition of the target alloy ingot, is obtainable by formulations. The total mass (mₜₒₜₐₗ) of any ingot is equal to the sum of the masses of every element in the ingot. Therefore:

$${m}_{total} = {\sum }_{i = First Element}^{All Elements} {m}_{i}$$

In many embodiments, the mass of element i in any ingot is equal to the mass fraction of element i, Yᵢ, multiplied by mₜₒₜₐₗ

mᵢ=Yᵢmₜₒₜₐₗ

In many embodiments, for element i, the conservation of mass for the element is:

$${m}_{i}^{Target} = {m}_{i}^{Received} + {m}_{i}^{Correction}$$

In many embodiments, to solve for the mass of element i in the correction alloy ingot the formulation is arranged as:

$${m}_{i}^{Correction} = {m}_{i}^{Target} - {m}_{i}^{Received}$$

Which, when expressed in terms of mass fractions and total ingot masses, for many embodiments is:

$${m}_{i}^{Correction} = {Y}_{i}^{Correction} {m}_{total}^{Correction} = {Y}_{i}^{Target} {m}_{total}^{Target} - {Y}_{i}^{Received} {m}_{total}^{Received}$$

In many embodiments, once the total masses of the mongrel alloy ingot and the correction alloy ingot are determined and the composition of the mongrel alloy ingot measured, the mass of each element in the correction alloy ingot is numerically solved by altering the composition of the target alloy ingot for a set of constraints that correlate to the desired characteristic (i.e., to form the target alloy).
In an exemplary embodiment to promote glass forming ability in alloy the system, the constraints are determined as follows:
The atomic fraction of element i, Xᵢ is defined as nᵢ the number of moles of atoms of element i divided by nₜₒₜₐₗ the total number of moles of atoms of every element in the ingot. nᵢ is given by dividing the mass of element i, mᵢ by the molar mass of element i, Mᵢ.

$${X}_{i} = \frac{{n}_{i}}{{n}_{total}}$$

$${n}_{i} = \frac{{m}_{i}}{{M}_{i}}$$

$${n}_{total} = {\sum }_{i = First Element}^{All Elements} {n}_{i}$$

The target alloy must possess sufficient glass-forming ability (GFA) to form a glass (amorphous structure). GFA is a function of composition, generally given in atomic percent or atomic fraction. GFA is defined as the inverse of the critical cooling rate R_{C}, which is also directly proportional to the critical casting thickness d_{C}.

$$GFA ( Target Composition ) = GFA ( {X}_{1} , {X}_{2} , … , {X}_{N} ) = \frac{1}{{R}_{C}} ∝ {d}_{C} > 1 mm$$

For example, in some embodiments for Zr/Ti BMGs to possess sufficient glass-forming ability, the constraint would be:

$$20 \% \leq {X}_{Zr} \leq 55 \%$$

$$5 \% \leq \text{?} \leq 40 \%$$

$$\text{?} \leq 12 \%$$

$$\text{?} \leq 12 \%$$

$$22 \% \leq \text{?} \leq 27 \%$$

$${X}_{Al} is minimized$$

$$\text{?} + \text{?} + \text{?} + {A}_{Al} \leq 42 \%$$

$$\text{?} \text{indicates text missing or illegible when filed}$$

Similar composition boundaries are implemented for the target and correction alloy in other embodiments.

In many embodiments, the precursor material/scrap feedstock (mongrel alloy) was intended to meet a predetermined specification and composition but was delivered out of specification. In many such embodiments, the mongrel alloy was the result of manufacturing problems. In some such embodiments, the manufacturing problem was a reaction with the atmosphere, a reaction with the crucible material, incomplete melting, insufficient homogenization, or some other process that changed the resultant material composition. In many embodiments, the mongrel alloy contains contaminants. In some embodiments, the contaminant is oxygen, carbon, metals not in the specification, ceramics, impurities, and/or inclusions.

In many embodiments, the properties of the target alloy that the mongrel alloy is processed into are not within the specification of the initial intended alloy. In many embodiments, the mongrel alloy is not able to be modified to meet the initial alloy specifications. In some such embodiments, an intended titanium or zirconium (or combination of both) alloy, resulted in a “mongrel” alloy with a composition out of specification and without the possibility of being brought back into specification. In many such embodiments, an excessive amount of new material would be required to dilute the contamination or meet the initial specification. In many cases, the mongrel alloy would normally be deemed scrap but can be salvaged by processing in accordance with numerous embodiments.

In various embodiments, the composition of the mongrel alloy is measured and analyzed. In some such embodiments, the mongrel alloy is analyzed through numerical or experimental methods. Numerous such embodiments result in a range of correction alloys with various new properties. In some such embodiments, a correction alloy is selected that minimizes the required mass of the correction alloy ingot. In other embodiments, the correction alloy that improves the mongrel alloy's properties the most is selected. i.e., the most significant property difference between the mongrel and the target alloy.

In many Zr-based BMG, the amorphous structure produces yield strength of more than 1500 MPa, hardness above 400 HV, and elastic modulus below 120 GPa. These properties are sufficient for many engineering applications regardless of the specific alloy composition. In many embodiments with Zr-based mongrel alloy compositions, glass forming ability and/or critical casting thickness are the properties for which the target alloy is selected.

In many titanium alloys, alpha-dominant microstructure is undesirable, and common impurities such as oxygen and carbon are alpha stabilizers. In some embodiments with mongrel alloys with compositions that contain titanium, alpha-dominant microstructure, the correction alloy ingots contain beta stabilizers. In many such embodiments, the target alloy is selected for a volume fraction of beta at or above 50%. In some such embodiments, the resulting target alloy is then utilized in camping equipment, sports equipment, jewelry, and watches.

### Exemplary Applications

In an exemplary scenario, a titanium alloy production that intended to produce a beta alloy resulted in a production batch that contained contaminants and impurities, resulting in a batch with alpha stabilizers; the batch of material is brittle and unsuitable for its intended application, and the batch would be scrapped. In accordance with some embodiments, a beta stabilizing correction alloy is added to the “scrap alloy,” resulting in a composition with ductility sufficient for non-critical applications. Titanium alloys are desired in many industries for their high strength and low density, but many potential applications do not need to be fabricated from certified material. When batches of “scrap” material are processed in accordance with numerous embodiments, the resultant material can be utilized in various such applications. In many such embodiments, the material may be used as watch cases, rings, jewelry, brackets, and other consumer products such as those that do not have demanding strength and ductility.

In another exemplary scenario, if the intended production alloy is an amorphous metal, but the feedstock that is produced is full of impurities or has the wrong composition such that it cannot be produced into an amorphous structure, the resulting material would likely have very little value or potential application. However, if processed in accordance with various embodiments, the alloy can be modified with a small amount of additional material so that the new alloy produced has the minimum glass-forming ability needed to be formed into an amorphous part. In accordance with many such embodiments the resulting alloy is then able to be processed with conventional manufacturing techniques or in new applications. The resultant alloy can be used in various non-structural components such as brackets, watch cases, jewelry, and other small, precision metal parts in many embodiments. In many embodiments, the resultant alloy has an amorphous metal structure. In some such embodiments, if the new application for the new alloy's only requirement is that the final part has an amorphous structure, numerous feedstock material combinations can be utilized.

### Exemplary Embodiments

### Ti-6-4

In an exemplary embodiment, a scrap (mongrel) alloy was processed into an amorphous product by processing it in accordance with the methodology of numerous embodiments. A correction alloy was prepared from Ti-6-4. In this exemplary embodiment, the correction alloy was also derived from a waste stream product; The Ti-6-4 crystalline correction alloy was prepared from 3D printing waste powder. The Ti-6-4 crystalline correction alloy was then combined in a 50:50 ratio with the “mongrel” alloy Zr45.9Cu19.7Be34.4 (in atomic %) to form the new alloy Ti45.1Zr20Cu8.6Al9.5V1.8Be15 (in atomic %). The new alloy produced was a bulk metallic glass (amorphous metal) with significantly different properties than the original waste products. The Ti-6-4 powder waste stream alloy has a melting point of 1600° C. and was combined into a bulk glass-forming alloy with a melting point of <800° C. The appearance of the alloy changed, and all of the mechanical properties changed (e.g., hardness, strength, elasticity, ductility, modulus, fracture toughness, fatigue limit, wear resistance, etc.) and was able to be utilized in new applications. For example, the new alloy is castable and injection moldable.

### Ti40Zr20Cu5Al5Be30

In another exemplary embodiment, mongrel alloy feedstock that initially had exceptionally poor mechanical properties, such as a low glass-forming-ability, was “compositionally steered” with a correction alloy into a target alloy capable of 3 mm thick BMG by mixing it with 25% by mass of a designed correction alloy.

Ti40Zr20Cu5Al5Be30 BMG is a low-density alloy that can be used as a substitute for Ti-6Al-4V in certain applications. It is a variant of the quaternary alloy Ti40Zr20Cu10Be30 that was originally developed for spacecraft, and it has a critical casting thickness of about 10 mm. Compared to other BMGs with similar composition, Ti40Zr20Cu10Be30 does not exhibit significant toughness in bending tests but has high strength and hardness, making it a good candidate for specific applications. However, due to its unique composition, it is difficult to produce at scale, and an attempt at scale production of the alloy resulted in a low-quality, off-composition (Ti37.01Zr18.49Cu6.15Al4.25Be31.58C2.01O0.51) alloy that was considered scrap.

Compared to the requested alloy, the commercially produced (mongrel) alloy had significantly higher concentrations of oxygen and carbon than are normally found in BMG alloys. The alloy couldn't be produced into a BMG at any usable thickness (and it couldn't be atomized for 3D printing due to the beryllium content). Rather than dispose of the material, the commercially received (mongrel) alloy was combined with a correction alloy in accordance with this disclosure and then manufactured into useable parts.

First, the mongrel alloy and the target properties for the target alloys were characterized. The mongrel alloy exhibited high hardness and low density, which are attractive mechanical properties for titanium-based alloys, but it was brittle, low strength, and crystallized into ordered phases. The characteristics optimized for in the target alloy produced using the commercial (mongrel) alloy were: a BMG, castable into amorphous parts at least 3 mm thick with a yield strength of at least 2 GPa. The hardness of the alloy should be greater than 500 Hv to have comparable properties with stainless steel and the density should be approximately 5 g/cm3 to have comparable properties to crystalline titanium alloys.

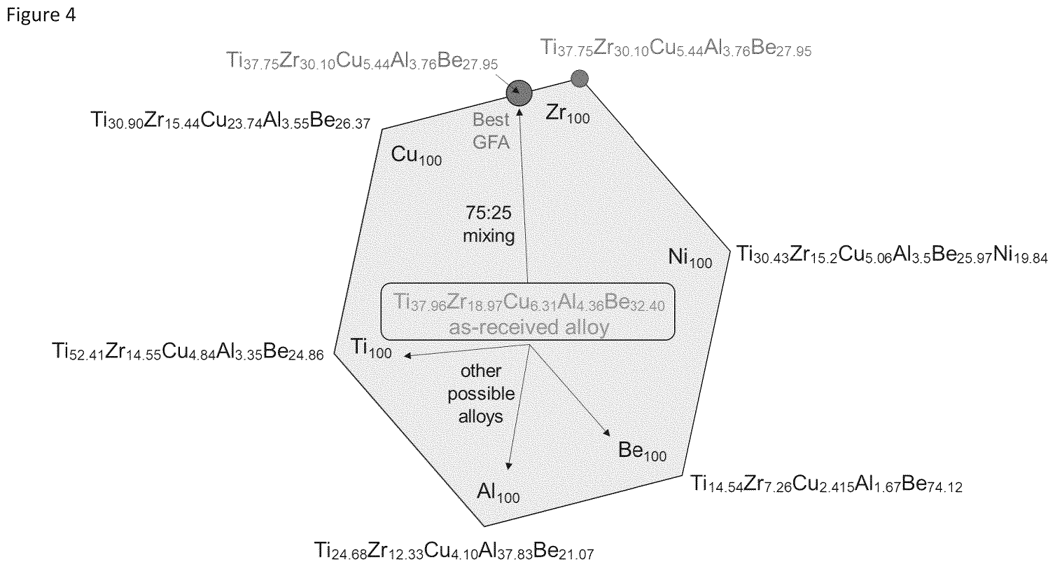

FIG. 4 shows a composition map that illustrates the possible compositions that could be created by combining the as-received commercial (mongrel) alloy with 25% by mass of pure elements. Five of the corners of the hexagon in FIG. 4 represent the composition that could be obtained by mixing the as-received commercial (mongrel) alloy with 25% of pure constituent elements (i.e., Zr100, Cu100, Ti100, Al100, and Be100). The sixth corner represents the addition of an element not found in the as-received alloy, Ni100. The as-received commercial (mongrel) alloy was deficient in Zr, so the correction ingots that were created to be used for “compositional steering” were all designed to ensure that the final composition had >20% Zr. The composition map shows that the only compositions that are in regions of high GFA are those where the as-received commercial (mongrel) alloy is mixed with Zr plus Cu and Ni. The alloy with the highest GFA in the compositional map was from combining the as-received commercial (mongrel) alloy with Zr75Cu25 (correction alloy). The target alloy made from combining the mongrel alloy with Zr75Cu25 (correction alloy), was amorphous at 3.5 mm thick, exhibited a >2 GPa yield strength, and was able to be manufactured into useable parts.

### Exemplary Data

A Ti40Zr20Cu5Al5Be30 BMG master alloy feedstock was produced commercially through vacuum-induction-melting (VIM) using graphite crucibles and poured into 19 mm diameter rods with a total mass of approximately 15 kg for the production run. The actual composition as measured through inductively coupled plasma mass spectrometry (ICP-MS) and light element analysis (LECO) of the alloy as received was Ti37.96Zr18.97Cu6.31Al4.36Be32.40 with measured impurities of 0.51 O2 and 2.01 C (0.19 wt % O2 and 0.56 wt. % C). The impurities were added unintentionally during alloying via reaction with the graphite crucible used in the VIM and oxygen that was gathered from the atmosphere during melting.

Typically, Be-containing BMGs are excellent glass formers and are fully amorphous when remelted into 25 g ingots. However, the as-received alloy was fully crystalline. Using the as-received alloy as a base mongrel alloy, target alloy compositions were developed by mixing the as-received alloy with various mass fractions of laboratory-grade (pure) materials. The correction ingot compositions were solved iteratively by manipulating the composition of the target alloy, assuring that its composition summed to 100% while keeping the compositional percentages of the correction ingot as positive values. Any target alloy that summed to 100% and resulted in a correction ingot with a positive value was a valid solution. Six solutions were used to create new target alloys to test the glass-forming region of the target alloy boundaries based on a 25% mass of correction alloy added to 75% of the as-received commercial alloy.

The as-received commercial BMG alloy could not be recycled by simply mixing (dilution) with laboratory-grade material of the same (intended) composition. Master “lab-grade commercial,” ingots were produced using high-purity elements melted under inert gas with the same composition as the commercial BMG (as measured through mass spectroscopy) but without the inclusion of the impurities of oxygen and carbon. The resulting alloy was also combined in a 50:50 mass ratio with the commercial alloy to create a third alloy with a 50% reduction in the level of impurities.

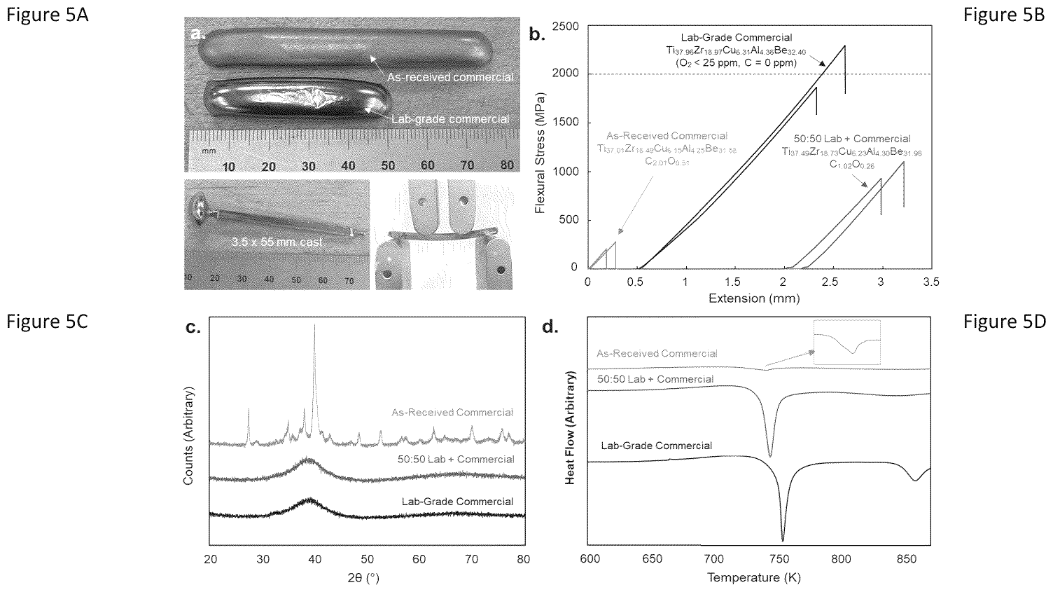

As depicted in FIGS. 5A through 5D, the three alloys were cast into 3.5 mm square beams, 55 mm long, and were subjected to four-point bending tests, XRD, and DSC to assess their strength, the extent of crystallization, and the glass forming ability. As illustrated by the XRD results shown in FIG. 5C, the commercial alloy was not a bulk glass former. The XRD results shown in FIG. 5C depict significant crystalline peaks superimposed over a broad, amorphous background, and the DSC results shown in FIG. 5D depict only a small crystallization event. In the four-point bending test, all of the alloys exhibited a flexural strength of 250 MPa and failed in a brittle manner, as is typical of a partially or fully crystallized BMG alloy.

The composition of the as-received commercial alloy, (Ti37.96Zr18.97Cu6.31Al4.36Be32.40)97.48C2.01O0.51, differs significantly from the BMG alloy that was requested, Ti40Zr20Cu5Al5Be30, which resulted in reduced GFA. In contrast, in the lab-grade commercial BMG, Ti37.96Zr18.97Cu6.31Al4.36Be32.4, the GFA and yield strength greatly improve. FIG. 5C depicts a XRD scan results of fully amorphous lab-grade alloy, (glass transition temperature of 643 K, and a ΔT of 107 K). The four-point bending tests shown in FIG. 5B average to approximately 2.0 GPa of flexural strength but with no plasticity, which indicates that the alloy is amorphous at 3.5 mm thickness (but is not particularly tough). Similar alloys in this BMG family typically exhibit flexural strengths up to 2.5 GPa with some bending plasticity. Removing O and C from the as-received commercial alloy improved the GFA considerably. FIG. 5 also illustrates the results from a mixture of 50:50 mass percent between the lab-grade and commercial alloy. The mixture effectively decreased the level of impurities without changing the composition. The recycled (mixture) alloy was fully amorphous via XRD but has a nearly flat thermal trace and a smaller ΔT of 99 K compared to the lab-grade alloy. Even though the 50:50 mixture was amorphous via XRD, it exhibited a low strength of 1.0 GPa in four-point bending, indicating that it was either partially crystalline, a low-toughness BMG, or both. Mixing the as-received commercial alloy with 50% virgin material did improve the GFA, but it did not improve the strength to the 2.0 GPa threshold expected for BMGs and thus could not be effectively recycled.

The concentration of O and C impurities in the as-received alloy was sufficiently large that the strength could not be sufficiently improved even by blending with virgin material up to 50% by mass. As such, the as-received (mongrel) alloy was processed with a “correction ingot” in accordance with this disclosure to improve the GFA and the strength of the as-received commercial (mongrel) alloy.

In this exemplary embodiment, the correction ingot was optimized to produce a target with an improved GFA of at least 3 mm and increase the flexural strength by using minimal additional materials and a ratio of 25% additions was selected for the correction alloy. The correction ingot was optimized for “steering” the as-received commercial alloy composition into a region with higher GFA. The as-received commercial (mongrel) alloy was deficient in Zr content at 19 at. %, which was lower than the 30-40 at. % that is observed in better glass-forming BMGs. Similarly, the Cu content at 6 at. % was lower than other BMGs at 8-12 at. %, and the Be content at 32 at. % was higher than other BMGs at 22-25 at. %. As such, a correction that would increase the Zr and Cu, decrease the Be, and possibly add Ni could result in a target alloy with the desired characteristics.

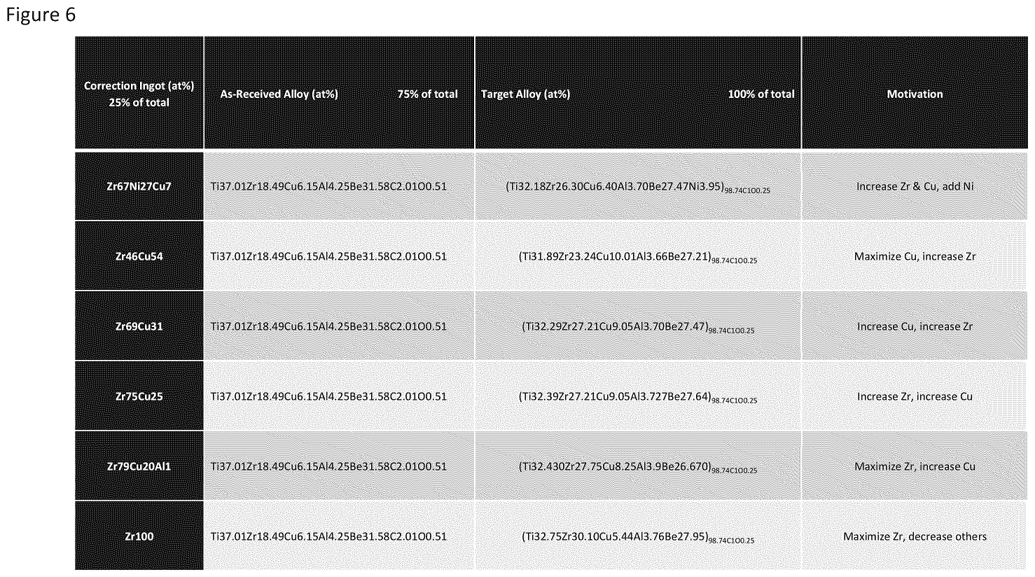

Six correction ingots were created to modify the as-received commercial (mongrel) alloy in a 75:25 mass ratio to determine the effect on GFA and strength. FIG. 6 shows the composition of the six correction alloys as well as the full composition of the target alloy resulting from mixing the correction alloy with the as-received commercial (mongrel) alloy in a 25:75 ratio. Five of the corrections increase the Zr and the Cu content in the as-received commercial (mongrel) alloy (Zr100, Zr79Cu20Al1, Zr75Cu25, Zr69Cu31, and Zr46Cu54), and one correction alloy adds Ni as well as Zr and Cu (Zr67Cu26Cu7). Each target alloy was made by mixing the as-received commercial (mongrel) alloy with the six correction alloys, respectively, in a 75:25 ratio. Each alloy was produced as ingots in an arc melter and then suction cast into 3.5 mm square beams, 55 mm long, for analysis.

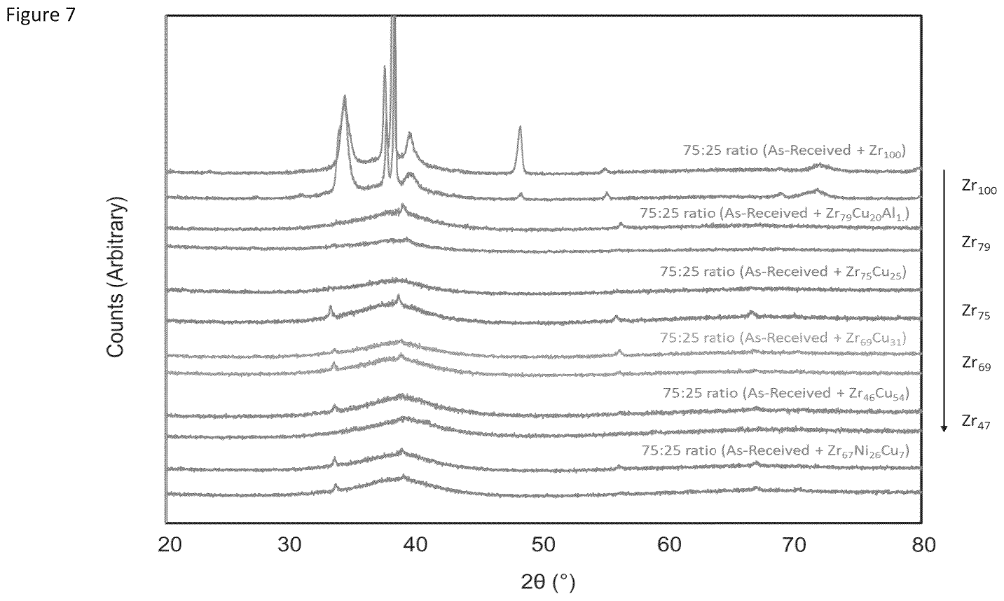

Bending tests, XRD, DSC, hardness, and speed of sound measurements were all performed on the cast beams at the center location where they fractured during four-point bending. FIG. 7 shows XRD scans from two different cast beams from each of the six target alloys. In almost every case, the XRD shows that the target alloys are nearly fully amorphous, even with only 25% additions. Small crystalline peaks are visible for some of the target alloys, indicating partial crystallization, but the alloys are mostly BMGs. The exception was the alloy mixed with Zr100, which showed more pronounced crystallization compared to the others. The best GFA was observed for the alloy with the addition of Zr75Cu25.

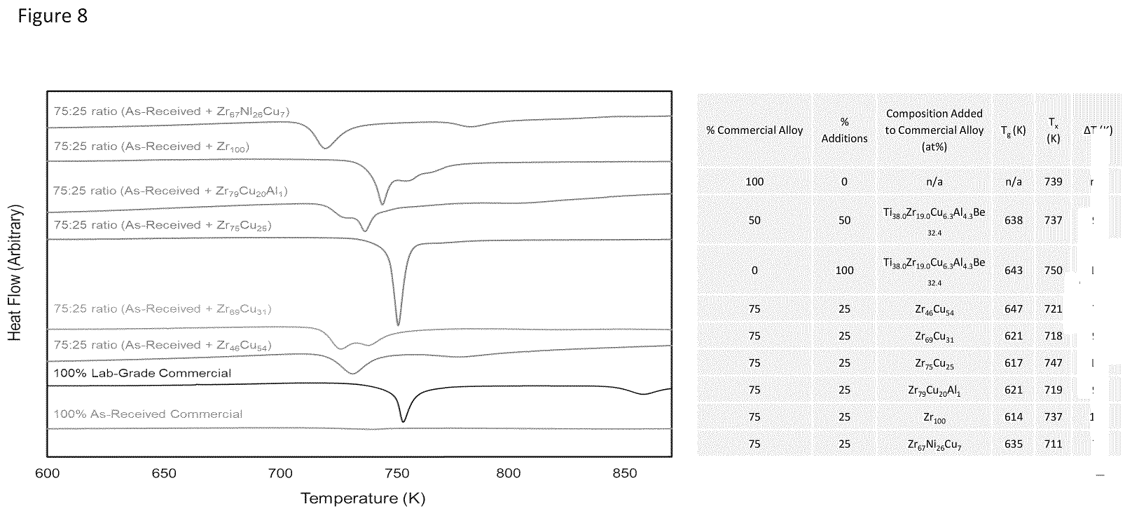

FIG. 8 shows the DSC curves, Tg, Tx, and ΔT as measured through DSC for all the target alloys and a comparison with the as-received commercial (mongrel) alloy and the lab-grade alloy. ΔT is typically a good indicator of the GFA and toughness of a BMG. The lab-grade version of the commercial alloy exhibits a ΔT of 107 K, and only two of the target alloys made with correction ingots exhibit a ΔT>100 K (Zr100 with ΔT=123 K and Zr75Cu25 with a ΔT of 130 K). Only the alloy using the correction ingot Zr75Cu25 exhibits a sharp crystallization event at a similar temperature to the lab-grade alloy (showing a stronger thermal trace and indicating that the target alloy is a better glass former than the lab-grade alloy). The other target alloys were also glassy (amorphous) but had crystallization peaks moved to lower temperatures, indicating (relatively) weaker glass forming.

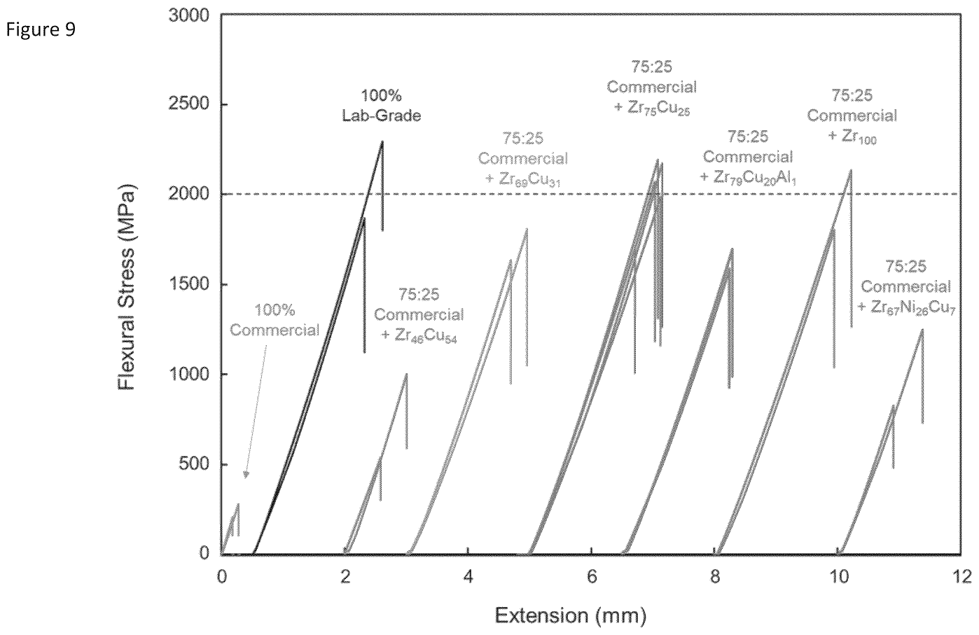

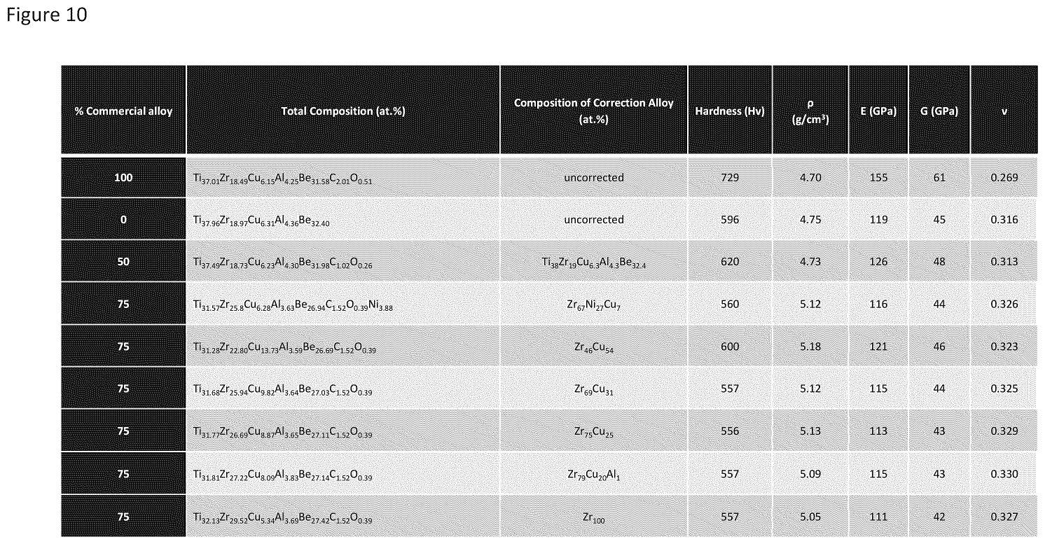

FIG. 9 shows four-point bending results on the six target alloys created using the correction ingots and the results for the as-received commercial (mongrel) and lab-grade alloy. In each target alloy, the flexural strength was significantly higher than the as-received (mongrel) alloy, and two of the new compositions exhibited a strength greater than 2 GPa. Additionally, the target alloy made with the correction ingot Zr75Cu25 showed the highest strength, exhibiting a strength>2 GPa. The target alloy with Zr100 shows similar strength despite being partially crystalline (shown via XRD and DSC). The target alloy made using Zr75Cu25, with total composition Ti31.77Zr26.69Cu8.87Al3.65Be27.11C1.52O0.39, was both amorphous at 3.5 mm thick and exhibited a >2 GPa yield strength. FIG. 10 shows the composition of the nine alloys, including oxygen and carbon, the correction alloy used to modify the as-received commercial (mongrel) alloy, and the achieved composition. As well as the Vicker's hardness, density, and elastic constants for each alloy (each alloy was cast into a 3.5 mm square beam, 55 mm long, and then measured at the center of those beams at the location where they fractured during four-point-bending tests and at least three beams of every composition were measured, and the averages values tabulated).

The exemplary data shows that processing alloys in accordance with many embodiments can overcome the challenges that limit traditional alloy production and reduce scrap. As a result, such embodiments have the potential to greatly improve the production and utilization of difficult-to-produce alloys in manufacturing, which can, in turn, improve performance in numerous industries.

### DOCTRINE OF EQUIVALENTS

This description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the terms “approximately” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

What is claimed is:

1. A process for recycling metal waste material into an alloy comprising,
providing a mongrel alloy that contains at least one contaminant wherein the at least one contaminant inhibits the formation of a selected structure with at least one selected property such that the addition of a percentage of uncontaminated mongrel alloy is insufficient for the formation of the selected structure,
combining an optimized ratio of the mongrel alloy and a correction alloy in a melting process configured to form a target alloy,
heating the mongrel alloy and the correction alloy until molten,
combining the molten mongrel and correction alloys into a homogenous combination,
solidifying the homogenous combination, wherein the solidified homogenous combination is of the selected structure and the at least one selected property.

2. The process of claim 1 wherein the mongrel alloy is predominately crystalline.

3. The process of claim 1 wherein the mongrel alloy is at least 50% by mass group IV elements from the periodic table.

4. The process of claim 1 wherein the at least one contaminant is selected from the group consisting of O, C, other metal, ceramic, and inclusions.

5. The process of claim 1 wherein the selected structure is a predominantly amorphous or glassy structure.

6. The process of claim 1 wherein the percentage is 50% or less.

7. The process of claim 1 wherein the mongrel alloy equals or exceeds the mass of the correction alloy.

8. The process of claim 1 wherein the optimized ratio between the mongrel alloy and the correction alloy is selected from the group consisting of, 50:50, 55:45, 60:40, 65:35, 70:30, 75:25, 80:20, 85:15, 90:10, and 95:5.

9. The process of claim 1 further comprising performing a manufacturing operation on the homogenous combination selected from the group consisting of casting, forging, extruding, atomizing, drawing, rolling, or melt spinning.

10. The process of claim 1 wherein the mongrel alloy is Ti40Zr20Cu5Al5Be30 in atomic % plus the at least one contaminant.

11. The process of claim 1 wherein the mongrel alloy is Ti90Al6V4 in weight % plus the at least one contaminant.

12. The process of claim 1, wherein the correction alloy predominantly comprises at least one element or combination selected from the group consisting of Zr, Ti, Cu, Ni, Fe, Nb, Ta, V, Al, and Be.

13. The process of claim 1 wherein the correction alloy is selected from the group consisting of Zr46Cu54, Zr69Cu31, Zr75Cu25, Zr79Cu20Al1, Zr100, and Zr67Ni26Cu7.

14. The process of claim 1 wherein the target alloy comprises the constituent elements of the mongrel alloy.

15. The process of claim 1, wherein the at least one selected property of the target alloy exceeds the at least one selected property of the mongrel alloy.

16. The process of claim 14 wherein the property is selected from the group consisting of strength, hardness, ductility, modulus, fatigue limit, wear resistance, abrasive resistance, density, thermal conductivity, solidus temperature, melting point, viscosity, color or appearance, elastic strain limit, biocompatibility, operating temperature, reactivity, castability, fracture toughness, and impact toughness.

17. The process of claim 1 wherein the target alloy has a yield strength of at least 1.0 GPa, a Young's modulus less than 150 GPa, a hardness greater than 400 Hv, and an elastic strain limit of greater than 1.4% before yielding.

18. The process of claim 1, wherein the target alloy has a glass forming ability of 3 mm amorphous and 2 GPa strength.

19. The process of claim 1 wherein the correction alloy is optimized for the least additions.

20. The process of claim 1 wherein the target alloy is optimized for the least additions.

21. A process for recycling waste material into bulk metallic glass alloy comprising,
providing a predominantly crystalline mongrel alloy that is at least 50% by mass group four elements and contains O or C, inhibiting the formation of a predominantly amorphous structure,
combining an optimized ratio of the mongrel alloy and a correction alloy in a furnace configured to form a target alloy, wherein the mongrel alloy equals or exceeds the mass of the correction alloy,
heating the mongrel alloy and the correction alloy until molten,
combining the molten mongrel and correction alloys into a homogenous combination,
quenching the homogenous combination, wherein the quenched homogenous combination is predominantly amorphous.

22. The process of claim 21 wherein the mongrel alloy is Ti40Zr20Cu5Al5Be30 in weight %.

23. The process of claim 21 wherein the mongrel alloy is Ti90Al6V4 in weight %.

24. The process of claim 21 wherein the mongrel alloy is titanium, zirconium, or hafnium.

25. The process of claim 21 wherein the correction alloy is selected from the group consisting of Zr, Cu, or a combination of Zr and Cu.

26. The process of claim 21 wherein the optimized ratio is 75:25 mongrel alloy to correction alloy.

27. A process for recycling waste material into bulk metallic glass alloy comprising,
providing a predominantly crystalline alloy that is at least 50% by mass group four elements and contains a contaminant, inhibiting the formation of a predominantly amorphous structure,
combining an optimized ratio of the predominantly crystalline alloy and a correction alloy in a furnace configured to form a target alloy, wherein the predominantly crystalline alloy equals or exceeds the mass of the correction alloy,
heating the mongrel alloy and the correction alloy until molten,
combining the molten predominantly crystalline alloy and correction alloys into a homogenous combination,
quenching the homogenous combination, wherein the quenched homogenous combination is predominantly amorphous.

28. The process of claim 24 wherein the predominantly crystalline alloy is Ti90Al6V4 in weight %.

29. The process of claim 24, wherein the correction alloy consists of Zr, CU, and Be.

30. The process of claim 24 wherein the optimized ratio is 50:50 predominantly crystalline alloy to correction alloy.
